(19) United States
(12) Patent Application Publication
(10) Pub. No.: US 2025/0284517 A1
(43) Pub. Date: Sep. 11, 2025

(54) Methods And Systems For Moving Virtual Logical Storage Units Between Data Center Management Servers

(71) Applicant: NETAPP, INC., San Jose, CA (US)

(72) Inventors: Rajiv Jain, Bangalore (IN); Anjali Mishra, Bangalore (IN); Vineeth Karinta, Apex, NC (US)

(21) Appl. No.: 18/601,726

(22) Filed: Mar. 11, 2024

(51) Int. Cl. G06F 9/455

(52) U.S. Cl. CPC G06F 9/45558; G06F 2009/45583

(57) ABSTRACT

A method and system uses a first storage container for a first data center management server and a second storage container for a second data center management server that are associated with at least one common flexible logical storage unit in a storage system through a storage interface appliance to move a virtual logical storage unit from the first data center management server to the second data center management server. In order to move the virtual logical storage unit, the virtual logical storage unit is detached from a first virtual computing instance of the first data center management server and then attached to a second virtual computing instance of the second data center management server without any storage level modifications in the storage system.

### TECHNICAL FIELD

The present disclosure relates to networked storage systems, and more particularly to moving logical storage units between different virtualization environments in networked storage systems.

### BACKGROUND

Various forms of storage systems are used today. These forms include direct attached storage (DAS) systems, network attached storage (NAS) systems, storage area networks (SANs), and others. Networked storage systems are commonly used for a variety of purposes, such as providing multiple users with access to shared data, backing up data and others.

A storage system typically includes at least one computing system executing a storage operating system for storing and retrieving data on behalf of one or more client computing systems (“clients”). The storage operating system stores and manages shared data containers in a set of mass storage devices. The storage operating system typically uses storage volumes for NAS systems (may also be referred to as volumes) (or logical unit numbers (LUNS) for SANs) to store data. Each volume may be configured to store data files (i.e., data containers or data objects), scripts, word processing documents, executable programs, and any other type of structured or unstructured data. From the perspective of a computing device using the storage system, each volume can appear to be a single storage drive. However, each volume can represent the storage space in one storage device, an aggregate of some or all the storage space in multiple storage devices.

Storage systems are used extensively in virtual environments where a physical resource is time-shared among a plurality of independently operating processor executable virtual machines. Typically, storage space is presented to a virtual machine as a virtual file or virtual disk. A storage drive (for example, C:\) is then presented on a computing device via a user interface within a virtual machine context. The virtual machine can use the virtual storage drive to access storage space to read and write information.

In some virtual environments, virtual machines are provided virtual volumes (vVols) to store data. vVols are logical structures addressable by a virtual machine for storing and retrieving data. vVols are part of a virtual datastore, referred to as a vVol datastore. The vVol datastore acts as a logical container for the vVols. Multiple virtual machines may use different vVols and different storage volumes of storage systems to store data. In some situations, it may be desirable to move vVols between different virtualization environments in networked storage systems. However, moving vVols typically involves moving the underlying data of the vVols stored on physical storage devices, which usually takes a significant amount of time to complete.

### SUMMARY

A method and system uses a first storage container for a first data center management server and a second storage container for a second data center management server that are associated with at least one common flexible logical storage unit in a storage system through a storage interface appliance to move a virtual logical storage unit from the first data center management server to the second data center management server. In order to move the virtual logical storage unit, the virtual logical storage unit is detached from a first virtual computing instance of the first data center management server and then attached to a second virtual computing instance of the second data center management server without any storage level modifications in the storage system.

A method executed by one or more processors in accordance with an embodiment of the invention comprises creating a first storage container for a first data center management server and a second storage container for a second data center management server, the first and second storage containers being associated with at least one common flexible logical storage unit in a storage system through a storage interface appliance, creating a first virtual computing instance for the first data center management server and a second virtual computing instance for the second data center management server, wherein the first virtual computing instance has a virtual logical storage unit in the first storage container, detaching the virtual logical storage unit in the first storage container from the first virtual computing instance of the first data center management server, and after detaching the virtual logical storage unit from the first virtual computing instance, attaching the virtual logical storage unit to the second virtual computing instance of the second data center management server so that the virtual logical storage unit is moved from the first data center management server to the second data center management server without any storage level modifications in the storage system. In some embodiments, the steps of this method are performed when program instructions contained in a non-transitory computer-readable storage medium are executed by one or more processors.

A system in accordance with an embodiment of the invention comprises memory and at least one processor configured to create a first storage container for a first data center management server and a second storage container for a second data center management server, the first and second storage containers being associated with at least one common flexible logical storage unit in a storage system through a storage interface appliance, create a first virtual computing instance for the first data center management server and a second virtual computing instance for the second data center management server, wherein the first virtual computing instance has a virtual logical storage unit in the first storage container, detach the virtual logical storage unit in the first storage container from the first virtual computing instance of the first data center management server, and after the virtual logical storage unit is detached from the first virtual computing instance, attach the virtual logical storage unit to the second virtual computing instance of the second data center management server so that the virtual logical storage unit is moved from the first data center management server to the second data center management server without any storage level modifications in the storage system.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

The foregoing features and other features will now be described with reference to the drawings of the various aspects of the present disclosure. In the drawings, the same components have the same reference numerals, and similar reference numbers may be used to identify similar elements. The illustrated aspects are intended to illustrate, but not to limit the present disclosure. The drawings include the following figures.

FIG. 1 shows a networked storage system in accordance with an embodiment of the invention.

FIG. 2 shows a representative virtualization environment, which may be included in the networked storage system shown in FIG. 1, in accordance with an embodiment of the invention.

FIG. 3 is a flow diagram of a process of moving a vVol from one data center management server to another data center management server in the networked storage system in accordance with an embodiment of the invention.

FIGS. 4A-4F illustrate the process depicted in the flow diagram of FIG. 3 in accordance with an embodiment of the invention.

FIG. 5 is a high-level block diagram showing an example of the architecture of a processing system in accordance with an embodiment of the invention.

FIG. 6 is a process flow diagram of a method executed by one or more processors in accordance with an embodiment of the invention.

### DETAILED DESCRIPTION

In one aspect, innovative computing technology is disclosed to move virtual logical storage units, e.g., virtual volumes (vVols), between different virtualization environments in a networked storage system. As described in detail below, one or more vVols can be almost instantaneously moved from one virtualization environment to another since the innovative technology does not require any storage-level changes. Details regarding the innovative technology are provided below.

As preliminary note, the terms “component”, “module”, “system,” and the like as used herein are intended to refer to a computer-related entity, either software-executing general-purpose processor, hardware, firmware and a combination thereof. For example, a component may be, but is not limited to being, a process running on a processor, a hardware-based processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), solid state drive, hard disk, EEPROM (electrically erasable programmable read only memory), non-volatile memory or any other storage device, in accordance with the claimed subject matter.

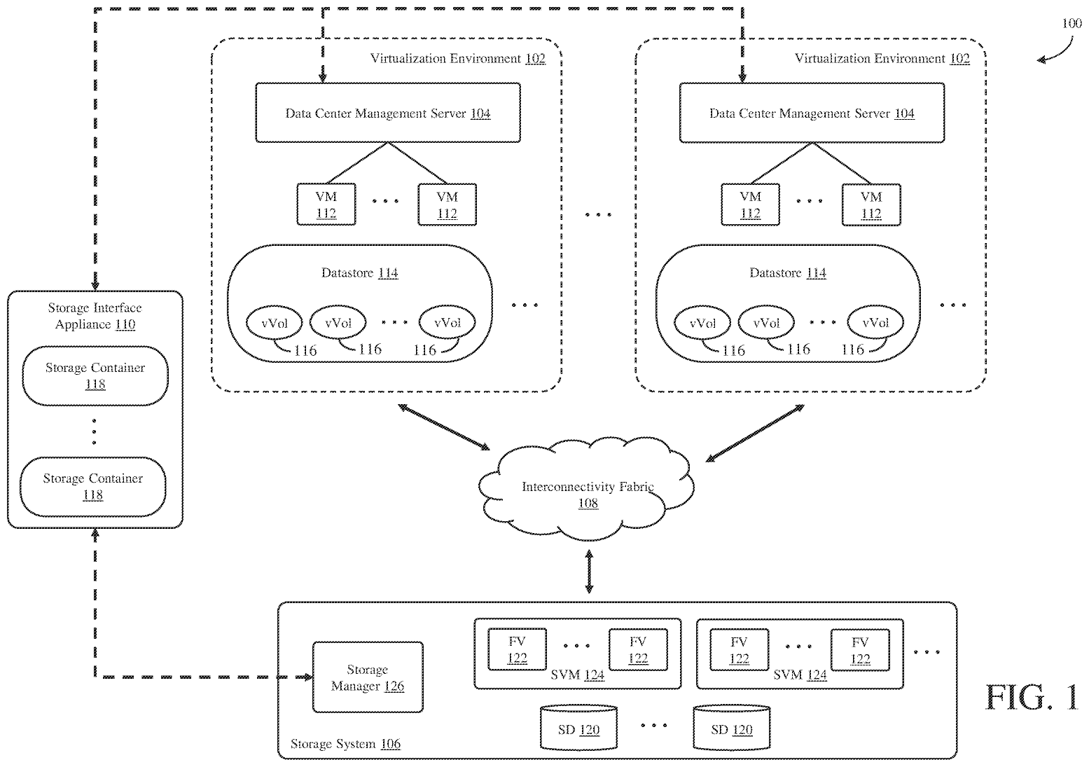

Turning now to FIG. 1, a networked storage system 100 in accordance with an embodiment of the invention is illustrated. In the illustrated embodiment, the system 100 includes multiple virtualization environments 102, each of which may be created and managed by a data center management server 104. The virtualization environments 102 are connected to a storage system 106 via an interconnectivity fabric 108. The storage system 106 provides storage resources to the virtualization environments 102, which are managed by a storage interface appliance 110.

Each of the virtualization environments 102 may include one or more virtual computing instances 112, which may operate as virtualized computer systems. As used herein, the term “virtual computing instance” refers to any software processing entity that can run on a computer system, such as a software application, a software process, a virtual machine and a container. A virtual machine is an emulation of a physical computer system in the form of a software computer that, like a physical computer, can run an operating system and applications. A virtual machine may be comprised of a set of specification and configuration files and backed by the physical resources of a physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines (VMs), although embodiments of the invention described herein are not limited to VMs.

Each virtualization environment 102 may include one or more datastores 114, which include logical storage units in the form of virtual volumes (vVols) 116 for the VMs 112 or other programs/applications/processes in that virtualized environment. Unlike traditional logical unit number (LUN) and Network File System (NFS) based storage, the vVols functionality may not require preconfigured volumes on a storage side. Instead, vVols can use a storage container, which is a pool of raw storage capacity or an aggregation of storage capabilities that a storage system can provide to vVols. The vVols 116 in the datastores 114 may include different types of vVols or other types of logical storage units, which are used to store various data for the VMs. As an example, the vVols 116 in the datastores 114 may include data, configuration and snapshot vVols. The datastores 114 of the virtualization environments 102 are supported by the storage resources of the storage system 106, and managed by the storage interface appliance 110.

Although the logical storage units 116 are described herein as being vVols, in other embodiments, the logical storage units 116 may include different type of logical storage units, such as first class disks (FCDs). Thus, the innovative technology described herein may be applied to moving FCDs, as well as vVols, between the virtualization environments 102.

In an embodiment, the virtualization environments 102, the storage system 106, the interconnectivity fabric 108 and/or the storage interface appliance 110 may be supported by a cloud provider that provides access to cloud-based storage via a cloud layer executed in a cloud computing environment. Cloud computing means computing capability that provides an abstraction between the computing resource and its underlying technical architecture (e.g., servers, storage, networks), enabling convenient, on-demand network access to a shared pool of configurable computing resources that may be rapidly provisioned and released with minimal management effort or service provider interaction. The term “cloud” herein is intended to refer to a network, for example, the Internet and cloud computing allows shared resources.

Typical cloud computing providers deliver common business applications online which are accessed from another web service or software like a web browser, while the software and data are stored remotely on servers. The cloud computing architecture uses a layered approach for providing application services. The first layer is an application layer that is executed at client computers. After the application layer is a cloud platform and cloud infrastructure, followed by a “server” layer that includes hardware and computer software designed for cloud specific services.

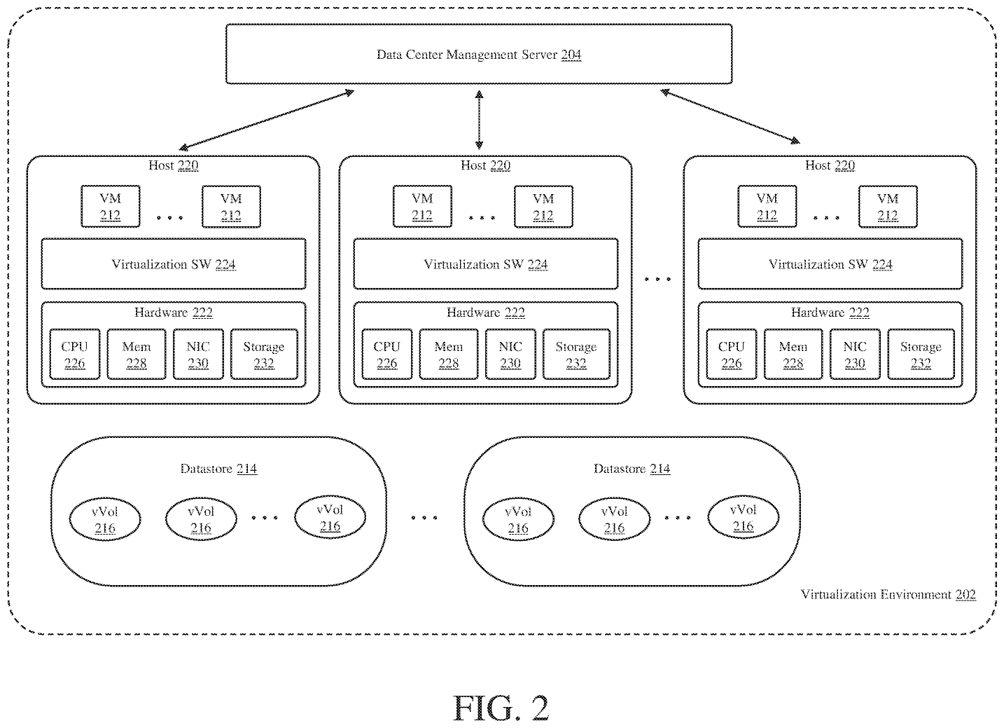

FIG. 2 shows a representative virtualization environment 202 that may be included in the networked storage system 100 in accordance with an embodiment of the invention. As shown in FIG. 2, the virtualization environment 202 includes a data center management server 204 and a number of host computers (hosts) 220. The virtualization environment 202 may include other components commonly found in virtualization environments in which VMs are deployed, such as components that provide and support software-defined networking.

The data center management server 204 operates to manage and monitor the hosts 220. The data center management server may be configured to allow an administrator to create one or more clusters of hosts, add hosts to the clusters and delete hosts from the clusters. The data center management server may also be configured to monitor the current configurations of the hosts and any virtual computing instances 212 running on the hosts, which are shown as VMs in the illustrated embodiment. The monitored configurations may include hardware and software configurations of each of the hosts. The monitored configurations may also include VM hosting information, i.e., which VMs are hosted or running on which hosts. The monitored configurations may also include information regarding the VMs running on the different hosts.

The data center management server 204 may also perform operations to manage the VMs 212 and the hosts 220. As an example, the data center management server may be configured to perform various resource management operations, including VM placement operations for either initial placement of VMs and/or load balancing. The process for initial placement of VMs may involve selecting suitable hosts for placement of the VMs based on, for example, memory and central processing unit (CPU) requirements of the VMs, the current memory and CPU loads on the hosts and the memory and CPU capacity of the hosts.

In some embodiments, the data center management server 204 may be a physical computer. In other embodiments, the data center management server may be implemented as one or more software programs running on one or more physical computers, such as the hosts 220, or running on one or more VMs, such as the VMs 212. In a particular implementation, the data center management server is a VMware vCenter™ server with at least some of the features available for such a server.

As illustrated in FIG. 2, each host 220 in the virtualization environment 202 includes hardware 222 and a virtualization software 224. The hardware 222 of each host 220 includes hardware components commonly found in a physical computer system, such as one or more processors 226, one or more system memories 228, one or more network interfaces 230 and one or more local storage devices 232 (collectively referred to herein as “local storage”). Each processor 226 can be any type of a processor, such as a CPU commonly found in a server. In some embodiments, each processor may be a multi-core processor, and thus, includes multiple independent processing units or cores. Each system memory 228, which may be random access memory (RAM), is the volatile memory of the host 220. The network interface 230 is an interface that allows the host computer to communicate with a network, such as the Internet. As an example, the network interface may be a network adapter. Each local storage device 232 is a nonvolatile storage, which may be, for example, a solid-state drive (SSD) or a magnetic disk.

The virtualization software (SW) 224 of the host 220, which may be referred to as a hypervisor or a virtual machine monitor (VMM), enables sharing of the hardware resources of that host by virtual computing instances, such as the VMs 212, running on the host computer. As an example, the virtualization software 224 may be a processor executed hypervisor layer provided by VMWare Inc., Hyper-V layer provided by Microsoft Corporation of Redmond, Washington or any other virtualization layer type. With the support of the virtualization software 224, the VMs 212 provide isolated execution spaces for guest software running on the VMs. In the illustrated embodiment, the virtualization software 224 is executed by the host 220. However, in other embodiments, the virtualization software 224 may be executed by an independent stand-alone computing system, often referred to as a hypervisor server or VMM server, where VMs are deployed on another computing system(s).

In an embodiment, the VMs 212 deployed in the virtualization environment 202 use vVols 216 in datastores 214, which are supported by a storage system, such as the storage system 106, for storing various information. Each VM 212 may use one or more vVols to store, but not limited to, disk data, configuration data and snapshot data. Thus, the vVols 216 may be used for VM files and virtual disks. In a particular implementation, the vVols 216 may be VMware vSphere Virtual Volumes.

In an embodiment, the hosts 220 have no direct access to the vVols 216 on the storage side. Instead, the hosts may use a logical input/output (I/O) proxy, which may be called a protocol endpoint, to communicate with a storage system, e.g., the storage system 106, on which the data of the vVols 216 are stored. The hosts may use these protocol endpoints to establish a data path on demand from the VMs 212 to their respective vVols.

Turning back to FIG. 1, the storage interface appliance 110 of the networked storage system 100 operates as an interface between the data center management servers 104 of the virtualization environments 102 and the storage system 106 to provide the vVol datastores 114 to the virtualization environments 102. In one aspect, the storage interface appliance 110 allows users to create and manage the vVols 116 for the virtualization environments 102, which are supported by the storage system 106, as described in more detail below. In order to create and manage the vVols 116, the storage interface appliance 110 creates storage containers 118, which represent the datastores 114 that are available to the virtualization environments 102. In an embodiment, the storage interface appliance 110 may be or may include a virtual volume storage provider, which may be called a vSphere APIs for Storage Awareness (VASA) provider. Thus, the storage interface appliance 110 may be configured to execute various capabilities found in a conventional VASA provider.

Components in the virtualization environments 102, such as the data center management servers 104 and the VMs 112, are communicably coupled to the storage system 106. In the illustrated embodiment, these components can access the storage system 106 through the interconnectivity fabric 108, which may include one or more local area networks (LANs), one or more wide area networks (WANs), the Internet and/or other network connections. As described herein, the term “communicably coupled” may refer to a direct connection, a network connection, or other connections to enable communication between computing and network devices.

The storage system 106 has access to a set of mass storage devices (SDs) 120, which may be used to store data for the vVols 116, as well as other data. The storage devices 120 may include writable storage device media, such as solid-state drives, storage class memory, magnetic disks, video tape, optical, DVD, magnetic tape, non-volatile memory devices for example, self-encrypting drives, or any other storage media adapted to store structured or non-structured data. The storage devices 120 may be organized as one or more groups of Redundant Array of Independent (or Inexpensive) Disks (RAID). The various aspects disclosed are not limited to any specific storage device or storage device configuration.

In the illustrated embodiment, the storage system 106 includes a number of flexible logical storage units in the form of flexible volumes (FVs) 122, which may increase or decrease their size as needed. The flexible volumes 122 may be created when the storage containers 118 for the datastores 114 are created. One storage container may have more than one flexible volumes, each of which can support one or more vVols. In an embodiment, a flexible volume may be a data container associated with a storage virtual computing instance 124, which may have multiple flexible volumes. In the illustrated embodiment, the storage virtual computing instance 124 is shown as being a storage VM (SVM). However, in other embodiments, the storage virtual computing instance 124 may be a different type of virtual computing instance. In addition, there may be multiple storage virtual computing instances 124 deployed in the storage system 106. In a particular implementation, the flexible volumes 122 may be Flex Vol® volumes, which are provided by NetApp Inc.

The storage system 106 further includes a storage manager 126, which operates to control and manage the storage devices 120 to support the flexible volumes 122 in the virtual computing instance 124. The storage manager 126 may communicate with the storage interface appliance 110 in order to manage the vVols 116 presented to the virtualization environments 102 via their data center management servers 104. In an embodiment, the storage manager 126 may include a storage operating system for storing and retrieving data on behalf of one or more client computing systems, e.g., the VMs 112. Although the storage system 106 is shown with a single storage manager, in other embodiments, the storage system 106 may include a cluster of storage controllers, which may be associated with cluster interconnect switches connecting the storage controllers. In a particular implementation, the storage manager 126 may include one or more storage controllers available from NetApp, Inc.

The storage system 106 may be used to store and manage information at the storage devices 120 based on requests generated by applications executed on the VMs 112 in the virtualization environments 102 or any other entities. The requests may be based on file-based access protocols, for example, the Common Internet File System (CIFS) protocol or Network File System (NFS) protocol, over the Transmission Control Protocol/Internet Protocol (TCP/IP). Alternatively, the requests may use block-based access protocols for storage area network (SAN) storage, for example, the Small Computer Systems Interface (SCSI) protocol encapsulated over TCP (iSCSI) and SCSI encapsulated over Fibre Channel (FC), object-based protocol or any other protocol.

In a typical mode of operation, one or more input/output (I/O) requests from the virtualization environments 102 are sent over the interconnectivity fabric 108 to the storage system 106. The I/O requests are received by the storage system 106, where one or more I/O commands are issued to the storage devices 120 to read or write the data on behalf of the requesting entities. Response to the I/O requests are then transmitted back to the requesting entities over the interconnectivity fabric 108.

Although the storage system 106 is shown as a stand-alone system, i.e., a non-cluster-based system, in other embodiments, the storage system 106 may have a distributed architecture; for example, a cluster-based system that may include a separate network module and storage module. Briefly, the network module is used to communicate with the requesting entities, while the storage module is used to communicate with the storage devices 120.

Alternatively, the storage system 106 may have an integrated architecture, where the network and data components are included within a single chassis. The storage system 106 may further be coupled through a switching fabric to other similar storage systems (not shown), which have their own local storage devices. In this way, all the storage devices can form a single storage pool, to which any client of any of the storage servers has access.

Prior to the adaptive aspects of the present disclosure, in order to move one of the vVols 116 from one virtualization environment managed by a data center management server to a different virtualization environment managed by another data center management server, the underlying data of the vVol stored in one or more physical storage devices may need to be copied, cloned or moved using a data migration/replication technology, for example, VMware vMotion technology. Thus, using conventional techniques, moving a vVol involves storage-level changes or physical movement or copying of stored data in one or more physical storage media, which may require a significant amount of time to complete. The innovative technology disclosed herein provides efficient means to move vVols from one virtualization environment to another virtualization environment without storage-based changes, which allows the vVols to be quickly moved between the virtualization environments, e.g., a fraction of milliseconds (almost instantaneously), as described in detail below.

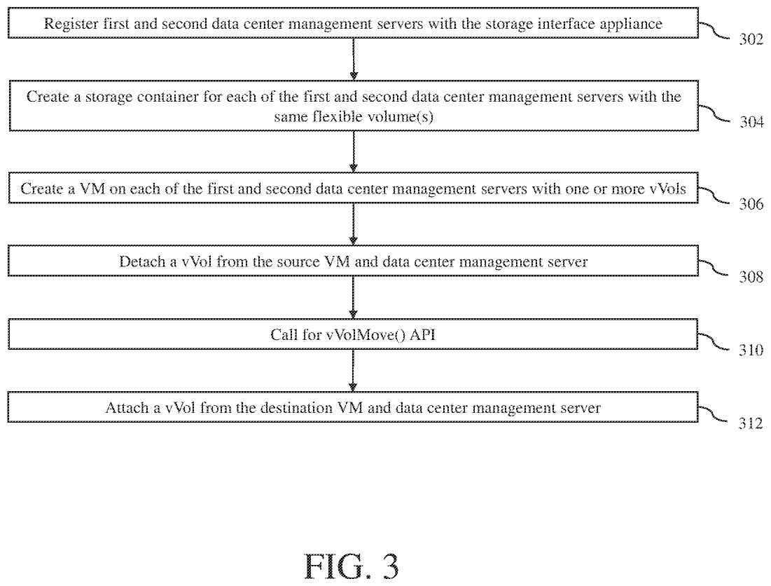

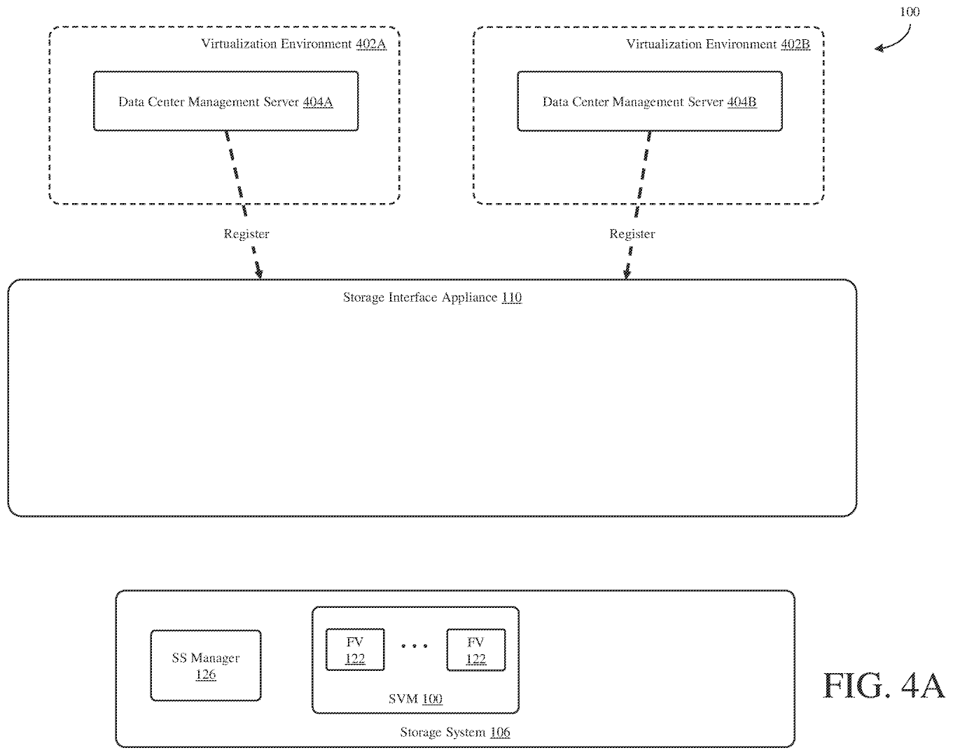

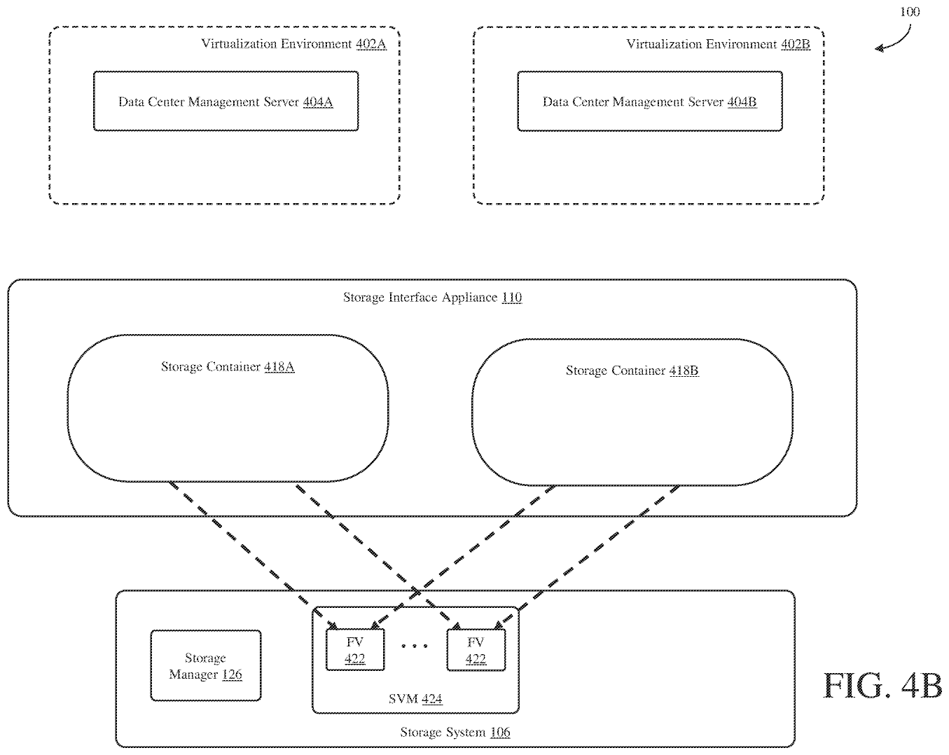

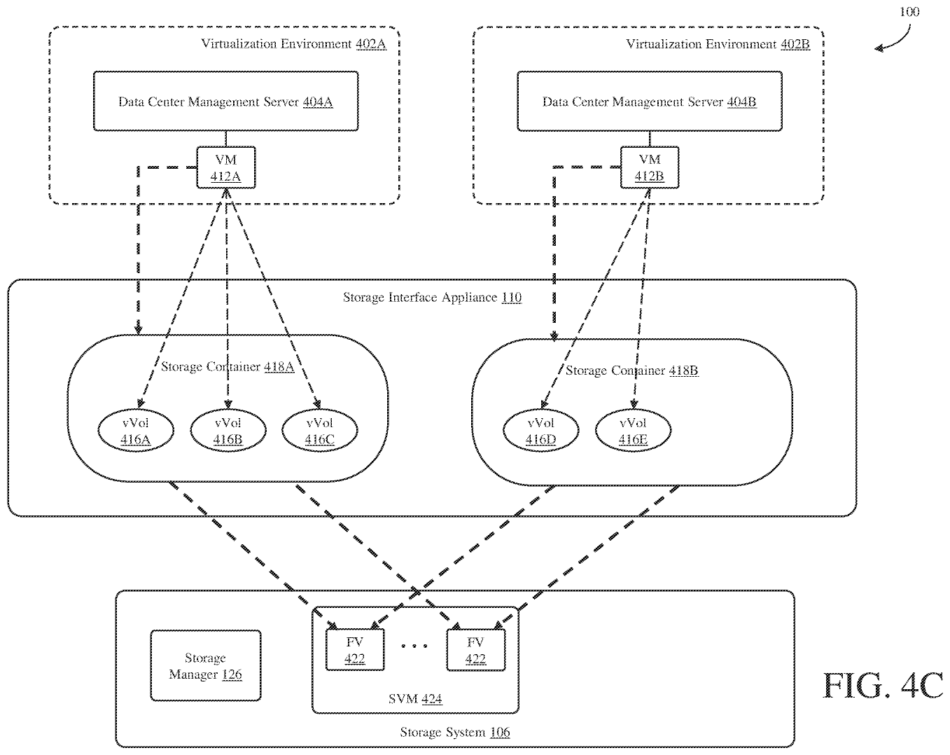

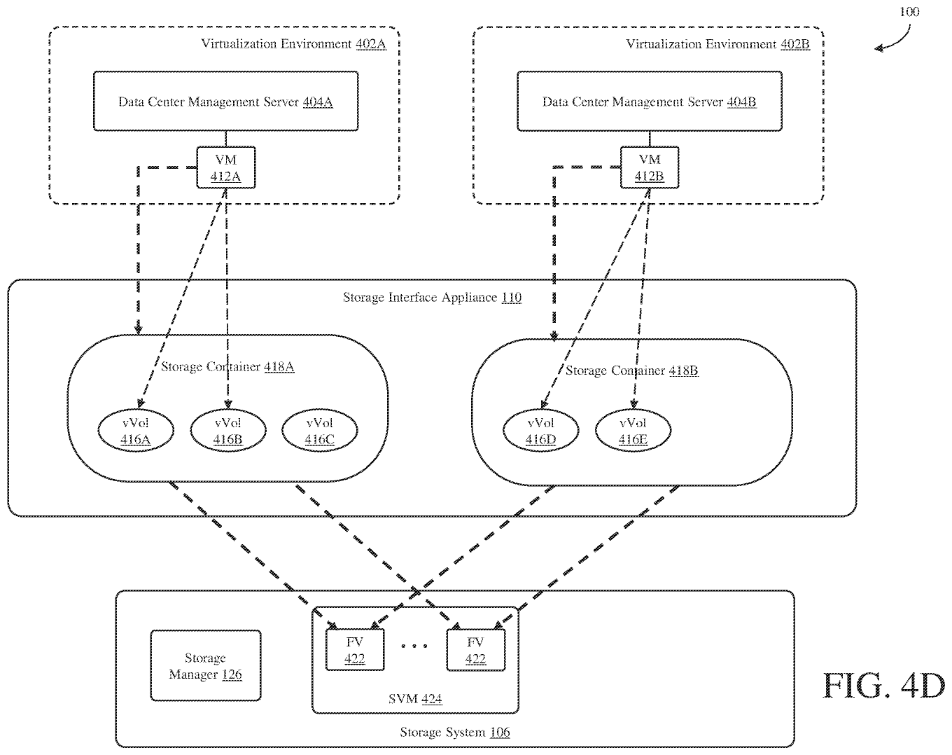

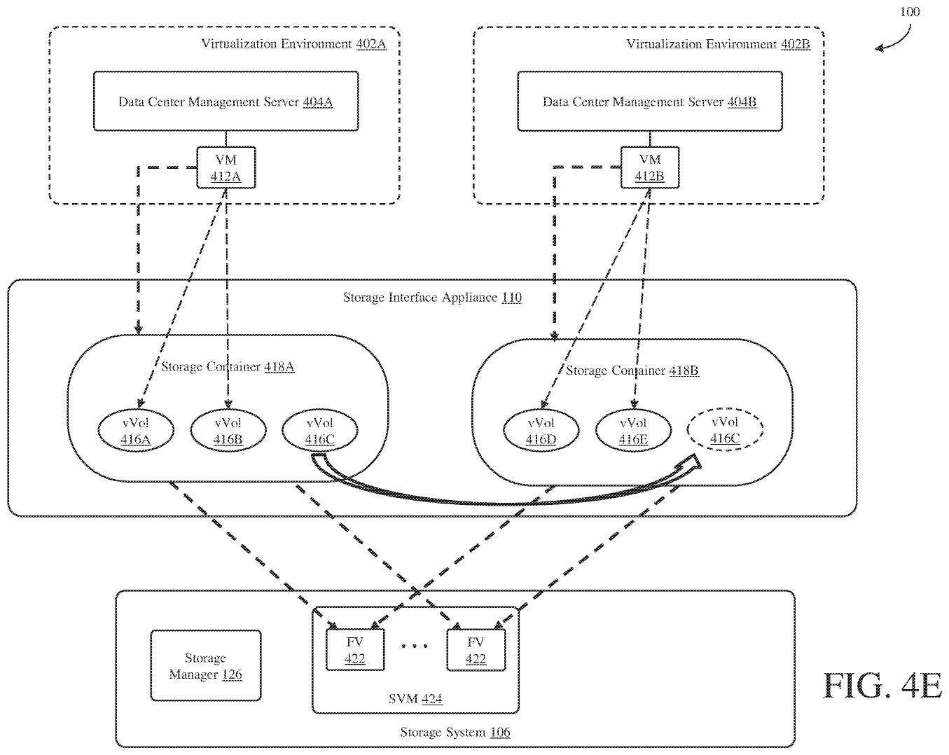

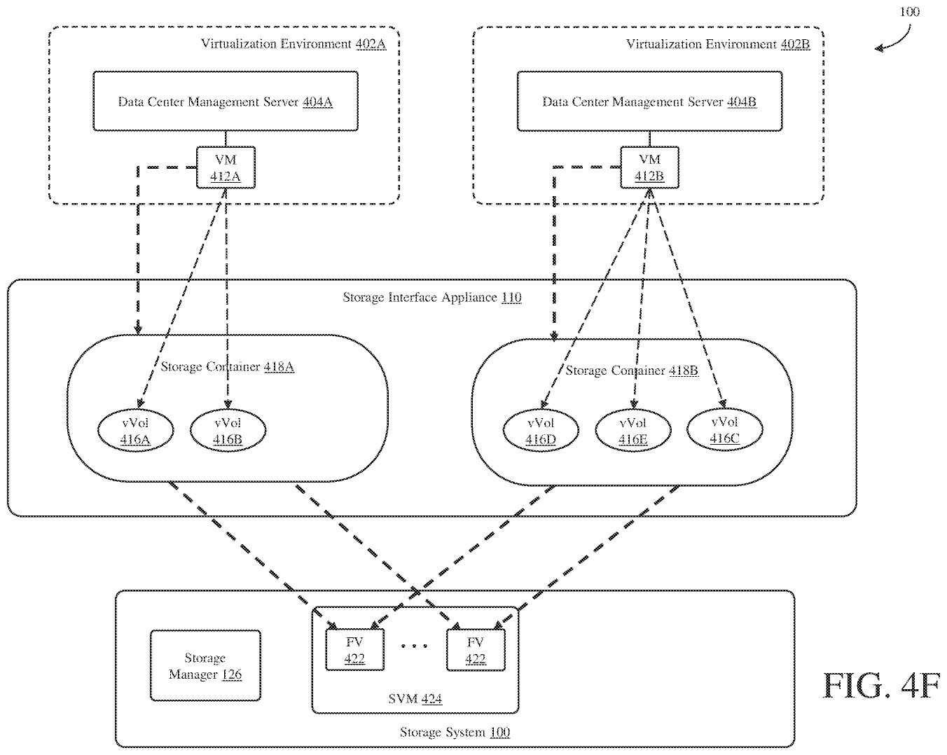

FIG. 3 shows a process for moving a vVol from a source data center management server, which manages a source virtualization environment, to a destination data center management server, which manages a source virtualization environment, in the networked storage system 100 in accordance with an embodiment of the invention. The process will be described with reference to FIGS. 4A-4F, which illustrate the networked storage system 100 at various points during the process. The process begins at step 302, where a first data center management server 404A in a first virtualization environment 402A and a second data center management server 404B in a second virtualization environment 402B are both registered with the storage interface appliance 110, as illustrated in FIG. 4A. In an embodiment, the first and second data center management servers 404A and 404B are registered with the storage interface appliance 110 by using a user interface (UI) available for the storage interface appliance, such as a UI provided by ONTAP tools for VMware vSphere made available by NetApp, Inc., to register each of the data center management servers to the storage interface appliance. The registration process may involve entering a Uniform Resource Locator (URL) with a domain name for multi-center deployment, one or more self-signed or Certificate Authority (CA) signed certificates to the URL, and credentials, such as VASA Provider username and VASA Provider password.

Next, at step 304, a storage container is created for each of the first and second data center management servers 404A and 404B with the same flexible volume or volumes. This step is illustrated in FIG. 4B, which shows that a storage container 418A is created for the first data center management server 404A and a storage container 418B is created for the second data center management server 404B. As shown in FIG. 4B, both of the storage containers 418A and 428B are mapped to or supported by the same flexible volumes 422 in a single SVM 424.

It is noted here that creating storage containers for different data center management centers that point to the same flexible volume(s) is unexpected because such configuration may create a potential conflict between the two protocol endpoints that may be created in the data center management centers for the same flexible volumes. Thus, one of ordinary skill in the art would most likely avoid creating such storage containers.

Next, at step 306, a VM is created on each of the first and second data center management servers 404A and 404B with one or more vVols. That is, a VM is created in a virtualization environment being managed by that data center management server. This step is illustrated in FIG. 4C, which shows that a VM 412A is created on the first data center management server 404A with vVols 416A, 416B and 416C in the storage container 418A, and a VM 412B is created on the second data center management server 404B with vVols 416D and 416E in the storage container 418B. Thus, the vVols 416A-416C of the VM 412A and the vVols 416D and 416E of the VM 412B are all supported by the same flexible volumes 422 in the storage VM 424.

Now, one or more of the vVols 416A-416E associated with the first data center management server 404A or the second data center management server 404B can be easily moved to the other data center management server. As an example, a user may want to move the vVol 416C from the first data center management server 404A to the second data center management server 404B. This example will be used to describe subsequent steps of the process to move one or more vVols from one data center management server to another data center management server in the networked storage system 100. Thus, in this example, the VM 412A and the data center management server 404A are the source VM and the source data center management server, and the VM 412B and the data center management server 404B are the destination VM and the destination data center management server with respect to the vVol 416C being moved.

Next, at step 308, the select vVol 416C is detached from the source VM 412A and data center management server 404A by the storage interface appliance 110. In an embodiment, this step may involve unbinding the vVol 416C from the source VM 412A. This vVol detachment may be initiated by the user using the same UI used for data center management server registration or a different UI associated with the storage interface appliance 110, which controls a feature available in the source data center management server 404A for vVol detachment via one or more application programming interfaces (APIs). This is illustrated in FIG. 4D, which shows that the vVol 416C has been detached from the source VM 412 and the source data center management server 404A.

Next, at step 310, a vVol move API of the storage interface appliance 110, which can be named vVolMove( ), may be called to initiate an operation to move the vVol 416C from the source data center management server 404A to the second data center management server 404B. In an embodiment, this vVol move API may be called by the user using the same UI used for data center management server registration or a different UI associated with the storage interface appliance 110. This is illustrated in FIG. 4E, which shows that the vVol 416C is to be moved from the storage container 418A for the source data center management server 404A to the storage container 418B for the destination data center management server 404B, which effectively migrates or moves the vVol 416C from the virtualization environment 402A under the control of the source data center management server 404A to the virtualization environment 402B under the control of the destination data center management server 404B.

Next, at step 312, in response to the vVol move API call, the vVol 416C is attached to the destination VM 412B and data center management server 404B by the storage interface appliance 110. In an embodiment, this step may involve binding the vVol 416C to the destination VM 412B. This vVol attachment may be executed by the storage interface appliance 110 by accessing a feature available in the destination data center management server 404B for vVol attachment via one or more APIs. In addition to attaching the vVol 416C to the destination VM 412B, other operations that may be performed in response to the vVol move API call may include, but not limited to, basic validations for the existence of the source and destination-related objects, and preparation for payload for calling APIs to the destination destination data center management server 404B with validated content. The vVol move API call may also involve a rollback mechanism in case of negative scenarios. This step is illustrated in FIG. 4F, which shows that the vVol 416C has been attached to the destination VM 412B and the destination data center management server 404B in response to the vVol move API call.

In other embodiments, the steps 308-312 may be automatically executed by the storage interface appliance 110 in response to user input or a command from another application/program. Thus, in these embodiments, minimal user input may be needed to move the vVol 416C from the source data center management server 404B to the destination data center management server 404B. Still in other embodiments, some or all of the steps 308-312 may be performed in response to user input.

As a result of the process, the vVol 416C has been moved from the source data center management server 404B to the destination data center management server 404B without any storage-level modifications. That is, no underlying data of the vVol 416C that is stored in the storage system 106 was copied or moved, which may have involved writing a significant amount of data to the storage devices 120 of the storage system 106. Thus, the process of moving the vVol 416C from the source data center management server 404B to the destination data center management server 404B can be quickly completed, possibly in a fraction of milliseconds.

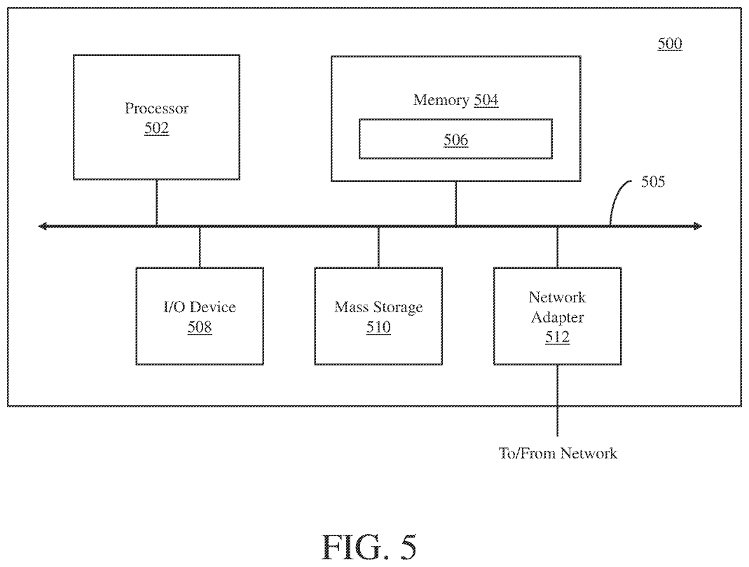

FIG. 5 is a high-level block diagram showing an example of the architecture of a processing system 500 in accordance with an embodiment of the invention, in which executable instructions for operations as described above can be implemented. The processing system 500 can represent modules of the data center management servers 104, the storage system 106 and the storage interface appliance 110. Note that certain standard and well-known components which are not germane to the present invention are not shown in FIG. 5.

The processing system 500 includes one or more processors 502 and memory 504, coupled to a bus system 505. The bus system 505 shown in FIG. 5 is an abstraction that represents any one or more separate physical buses and/or point-to-point connections, connected by appropriate bridges, adapters and/or controllers. The bus system 505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 502 are the central processing units (CPUs) of the processing system 500 and, thus, control its overall operation. In certain aspects, the processors 502 accomplish this by executing programmable instructions stored in the memory 504. Each processor 502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 504 represents any form of random-access memory (RAM), read-only memory (ROM), flash memory, or the like, or a combination of such devices. The memory 504 includes the main memory of the processing system 500. Instructions 506 which implements techniques introduced above may reside in and may be executed by the processors 502 from the memory 504. For example, the instructions 506 may include code used for executing the steps of FIG. 3 as well running various applications/processes running the networked storage system 100, such as the data center management centers 104, the VMs 112, the storage interface appliance 110 and the storage manager 126.

Also connected to the processors 502 through the bus system 505 are one or more internal mass storage devices 510, and a network adapter 512. The internal mass storage devices 510 may be or may include any conventional medium for storing large volumes of data in a non-volatile manner, such as one or more magnetic or optical based disks. The network adapter 512 provides the processing system 500 with the ability to communicate with remote devices (e.g., storage servers) over a network and may be, for example, an Ethernet adapter, a Fibre Connector (FC) adapter, or the like. The processing system 500 also includes one or more input/output (I/O) devices 508 coupled to the bus system 505. The I/O devices 508 may include, for example, a display device, a keyboard, a mouse, etc.

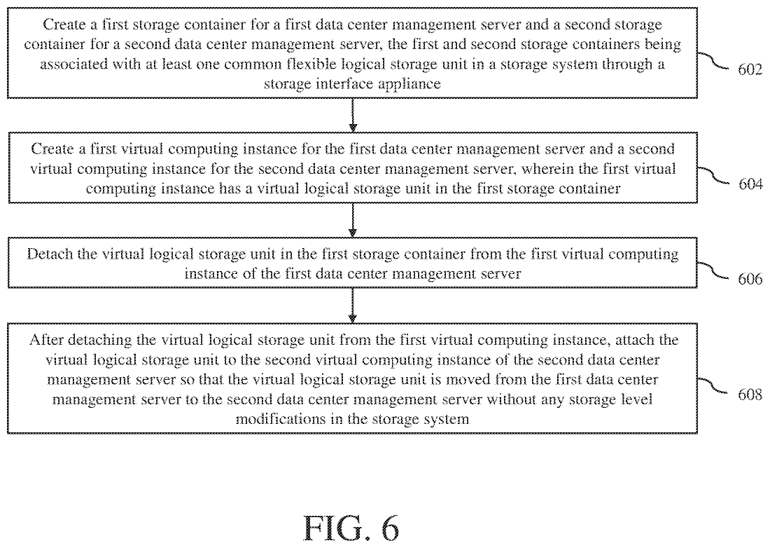

A method executed by one or more processors in accordance with an embodiment of the invention is now described with reference to a flow diagram of FIG. 6. At block 602, a first storage container for a first data center management server and a second storage container for a second data center management server are created. The first and second storage containers are associated with at least one common flexible logical storage unit in a storage system through a storage interface appliance. At block 604, a first virtual computing instance for the first data center management server and a second virtual computing instance for the second data center management server are created. The first virtual computing instance has a virtual logical storage unit in the first storage container. At block 606, the virtual logical storage unit in the first storage container is detached from the first virtual computing instance of the first data center management server. At block 608, after detaching the virtual logical storage unit from the first virtual computing instance, the virtual logical storage unit is attached to the second virtual computing instance of the second data center management server so that the virtual logical storage unit is moved from the first data center management server to the second data center management server without any storage level modifications in the storage system.

Methods and apparatus for moving vVols between data center management centers have been described. Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the present disclosure, as will be recognized by those of ordinary skill in the art.

Similarly, reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A method executed by one or more processors, comprising:
creating a first storage container for a first data center management server and a second storage container for a second data center management server, the first and second storage containers being associated with at least one common flexible logical storage unit in a storage system through a storage interface appliance;
creating a first virtual computing instance for the first data center management server and a second virtual computing instance for the second data center management server, wherein the first virtual computing instance has a virtual logical storage unit in the first storage container;
detaching the virtual logical storage unit in the first storage container from the first virtual computing instance of the first data center management server; and
after detaching the virtual logical storage unit from the first virtual computing instance, attaching the virtual logical storage unit to the second virtual computing instance of the second data center management server so that the virtual logical storage unit is moved from the first data center management server to the second data center management server without any storage level modifications in the storage system.

2. The method of claim 1, wherein detaching the virtual logical storage unit includes using at least one application programming interface of the first data center management server to detach the virtual logical storage unit in the first storage container from the first virtual computing instance of the first data center management server.

3. The method of claim 1, wherein attaching the virtual logical storage unit includes using at least one application programming interface of the second data center management server to attach the virtual logical storage unit to the second virtual computing instance of the second data center management server.

4. The method of claim 1, further comprising registering both the first data center management server and the second data center management server to the storage interface appliance.

5. The method of claim 1, wherein the storage interface appliance includes a virtual volume storage provider and wherein the virtual logical storage unit is a virtual volume.

6. The method of claim 1, wherein attaching the virtual logical storage unit to the second virtual computing instance is executed in response to a call for an application programming interface of the storage interface appliance to move the virtual logical storage unit to the second virtual computing instance.

7. The method of claim 1, wherein the first virtual computing instance is a virtual machine managed by the first data center management server and the second virtual computing instance is a virtual machine managed by the second data center management server.

8. The method of claim 1, wherein the at least one common flexible logical storage unit includes a flexible volume in a storage virtual computing instance running in the storage system.

9. The method of claim 1, wherein the at least one common flexible logical storage unit is associated with one or more protocol endpoints.

10. A non-transitory computer-readable storage medium containing program instructions, wherein execution of the program instructions by one or more processors of a computer causes the one or more processors to perform steps comprising:
creating a first storage container for a first data center management server and a second storage container for a second data center management server, the first and second storage containers being associated with at least one common flexible logical storage unit in a storage system through a storage interface appliance;
creating a first virtual computing instance for the first data center management server and a second virtual computing instance for the second data center management server, wherein the first virtual computing instance has a virtual logical storage unit in the first storage container;
detaching the virtual logical storage unit in the first storage container from the first virtual computing instance of the first data center management server; and
after detaching the virtual logical storage unit from the first virtual computing instance, attaching the virtual logical storage unit to the second virtual computing instance of the second data center management server so that the virtual logical storage unit is moved from the first data center management server to the second data center management server without any storage level modifications in the storage system.

11. The non-transitory computer-readable storage medium of claim 10, wherein detaching the virtual logical storage unit includes using at least one application programming interface of the first data center management server to detach the virtual logical storage unit in the first storage container from the first virtual computing instance of the first data center management server.

12. The non-transitory computer-readable storage medium of claim 10, wherein attaching the virtual logical storage unit includes using at least one application programming interface of the second data center management server to attach the virtual logical storage unit to the second virtual computing instance of the second data center management server.

13. The non-transitory computer-readable storage medium of claim 10, wherein steps further comprise registering both the first data center management server and the second data center management server to the storage interface appliance.

14. The non-transitory computer-readable storage medium of claim 10, wherein the storage interface appliance includes a virtual volume storage provider and wherein the virtual logical storage unit is a virtual volume.

15. The non-transitory computer-readable storage medium of claim 10, wherein attaching the virtual logical storage unit to the second virtual computing instance is executed in response to a call for an application programming interface of the storage interface appliance to move the virtual logical storage unit to the second virtual computing instance.

16. The non-transitory computer-readable storage medium of claim 10, wherein the first virtual computing instance is a virtual machine managed by the first data center management server and the second virtual computing instance is a virtual machine managed by the second data center management server.

17. The non-transitory computer-readable storage medium of claim 10, wherein the at least one common flexible logical storage unit includes a flexible volume in a storage virtual computing instance running in the storage system.

18. The non-transitory computer-readable storage medium of claim 10, wherein the at least one common flexible logical storage unit is associated with one or more protocol endpoints.

19. A system comprising:
memory; and
at least one processor configured to:
create a first storage container for a first data center management server and a second storage container for a second data center management server, the first and second storage containers being associated with at least one common flexible logical storage unit in a storage system through a storage interface appliance;
create a first virtual computing instance for the first data center management server and a second virtual computing instance for the second data center management server, wherein the first virtual computing instance has a virtual logical storage unit in the first storage container;
detach the virtual logical storage unit in the first storage container from the first virtual computing instance of the first data center management server; and
after the virtual logical storage unit is detached from the first virtual computing instance, attach the virtual logical storage unit to the second virtual computing instance of the second data center management server so that the virtual logical storage unit is moved from the first data center management server to the second data center management server without any storage level modifications in the storage system.

20. The system of claim 19, wherein the storage interface appliance includes a virtual volume storage provider and wherein the virtual logical storage unit is a virtual volume.
